(19) United States
(12) Patent Application Publication
(10) Pub. No.: US 2026/0369200 A1
(43) Pub. Date: Nov. 19, 2026

(54) MULTIPLE DEMURA COMPENSATION METHOD, PROCESSING CIRCUIT AND DISPLAY DEVICE

(71) Applicant: NOVATEK Microelectronics Corp., Hsin-Chu (TW)

(72) Inventors: Zi-Yi Lian, Miaoli County (TW); Yen-Tao Liao, Hsinchu City (TW)

(73) Assignee: NOVATEK Microelectronics Corp., Hsin-Chu (TW)

(21) Appl. No.: 19/207,386

(22) Filed: May 14, 2025

(51) Int. Cl. G09G 3/20; G06T 7/00

(52) U.S. Cl. CPC G09G 3/2007; G06T 7/0002; G06T 2207/30168; G09G 2320/0233

(57) ABSTRACT

A multiple Demura compensation method, comprising obtaining first compensation curve equations with respect to pixels of a display panel, wherein the first compensation curve equations being determined based on first compensation values of a first captured image associated with an input image; capturing a second captured image based on a compensated input image shown on the display panel, wherein the compensated input image being determined according to the input image and the first compensation curve equations; determining second compensation values of pixels of the display panel according to the second captured image and downsampling the second compensation values to generate second downsampled compensation values; determining second compensation curve equations according to the second downsampled compensation values; and calculating the first compensation curve equations and the second compensation curve equations to generate output compensation curve equations with respect to the pixels of the display panel.

### BACKGROUND OF THE INVENTION

### 1. Field of the Invention

The present invention relates to a multiple Demura compensation method, a processing circuit and a display device, and more particularly, to a multiple Demura compensation method, a processing circuit and a display device for eliminating panel Mura defect.

### 2. Description of the Prior Art

With development of display technology, display devices, such as organic light emitting diode (OLED) displays, micro LED displays, liquid crystal displays (LCDs), are widely applied in various electronic products. Quality requirements for the display devices are becoming higher and higher. The Mura phenomenon is a kind of display defect on a display panel with uneven brightness. The Mura phenomenon may occur due to the deviation of the panel current caused by the uneven material properties of thin-film transistors (TFTs). Demura technology can be used to compensate pixel luminance to improve the Mura phenomenon occurred on the display panel. Current Demura compensation method is to capture the display conditions of the display panel to generate captured image information by using a camera and to quantify the Mura defect of the captured image information into quantized values. Further, the grayscale of the pixel can be compensated according to the corresponding quantized values. However, traditional Demura compensation method needs to store a large amount of pixel data for compensation, thus requiring physical memory with large storage capacity. In addition, the Mura defect on the panel usually cannot be accurately compensated due to the mutual coupling influence after pixel compensation and/or the camera capture error, thus leading to unexpected compensation result. Thus, there is a need for improvement.

### SUMMARY OF THE INVENTION

It is therefore a primary objective of the present invention to provide a multiple Demura compensation method, a processing circuit and a display device for eliminating panel Mura defect, in order to resolve the aforementioned problems.

An embodiment of the present invention discloses a multiple Demura compensation method, comprising obtaining first compensation curve equations with respect to pixels of a display panel, wherein the first compensation curve equations being determined based on first compensation values of a first captured image associated with an input image; capturing a second captured image based on a compensated input image shown on the display panel, wherein the compensated input image being determined according to the input image and the first compensation curve equations; determining second compensation values of pixels of the display panel according to the second captured image and downsampling the second compensation values to generate second downsampled compensation values; determining second compensation curve equations according to the second downsampled compensation values; and calculating the first compensation curve equations and the second compensation curve equations to generate output compensation curve equations with respect to the pixels of the display panel.

An embodiment of the present invention discloses a processing circuit, wherein the processing circuit is configured to obtain first compensation curve equations with respect to pixels of a display panel, wherein the first compensation curve equations are determined based on first compensation values of a first captured image associated with an input image, the processing circuit is configured to determine second compensation values of the pixels of the display panel according to a second captured image and downsample the second compensation values to generate second downsampled compensation values, wherein the second captured image is captured based on a compensated input image shown on the display panel, and the compensated input image is determined according to the input image and the first compensation curve equations, wherein the processing circuit is configured to determines second compensation curve equations according to the second downsampled compensation values and calculate the first compensation curve equations and the second compensation curve equations to generate output compensation curve equations with respect to the pixels of the display panel.

An embodiment of the present invention discloses a display device, comprising a display panel; a memory, configured to store first compensation curve equations with respect to pixels of a display panel, wherein the first compensation curve equations are determined based on first compensation values of a first captured image associated with an input image; and a processing circuit, configured to determine second compensation values of the pixels of the display panel according to a second captured image and downsample the second compensation values to generate second downsampled compensation values, wherein the second captured image is captured based on a compensated input image shown on the display panel, and the compensated input image is determined according to the input image and the first compensation curve equations; wherein the processing circuit determines second compensation curve equations according to the second downsampled compensation values, and calculates the first compensation curve equations and the second compensation curve equations to generate output compensation curve equations with respect to the pixels of the display panel.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a display device according to an embodiment of the present invention.

FIG. 2 is a flow diagram of a procedure according to an embodiment of the present invention.

FIG. 3 is a flow diagram of determining the first compensation curve equation according to an embodiment of the present invention.

FIG. 4 is a schematic diagram illustrating operations of capturing the display panel to generate captured image according to an embodiment of the present invention.

FIG. 5 is a flow diagram of determining the second compensation curve equations according to an embodiment of the present invention.

FIG. 6 is a flow diagram of determining the output compensation curve equations according to an embodiment of the present invention.

FIG. 7 is a schematic diagram illustrating the merge operation for the first compensation curve equation and the second compensation curve equation according to an embodiment of the present invention.

### DETAILED DESCRIPTION

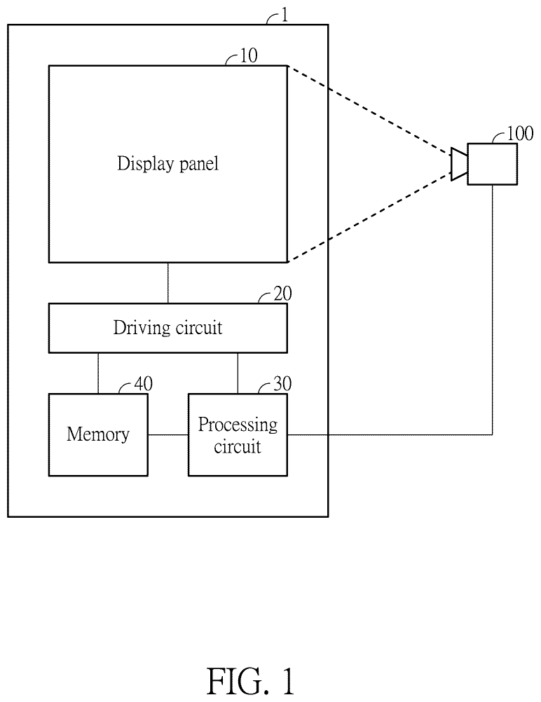

FIG. 1 is a schematic diagram of a display device 1 according to an embodiment of the present invention. The display device 1 may be utilized in an electronic product, such as smart phone, laptop, tablet, television, and monitor. The display device 1 includes a display panel 10, a driving circuit 20, a processing circuit 30 and a memory 40. The display panel 10 could display image frames. Based on a design requirement, the display panel 10 may be any type of display panel, for example, an organic light emitting diode (OLED) display panel, a mini-LED panel, a micro-LED panel or a liquid crystal display (LCD) panel, but not limited thereto. The display panel 10 may include a plurality of pixels arranged in a matrix pattern. The display panel 10 could display image frames controlled by the driving circuit 20.

The driving circuit 20 may be coupled to the display panel 10 and configured to generate driving signals to control and drive pixels of the display panel 10 for display purpose. The driving circuit 20 may include a timing control (TCON) circuit, a gate driver, a gate on array circuit, a source driver, and/or other driving circuits according to design requirements. The driving circuit 20 could be implemented in an integrated circuit (IC) as a display driver IC (DDIC). The processing circuit 30 is configured to determine first compensation curve equations associated with an input image and second compensation curve equations associated with compensated input image, and calculate the first compensation curve equations and the second compensation curve equations to generate output compensation curve equations for the display panel 10. The driving circuit 20 and the processor circuit 30 may be separate semiconductor chips or may be integrated in one semiconductor chip. The processor circuit 30 may be integrated into the driving circuit 20. The memory 40 may be a non-volatile memory (NVM) such as flash memory, and this should not be a limitation of the invention.

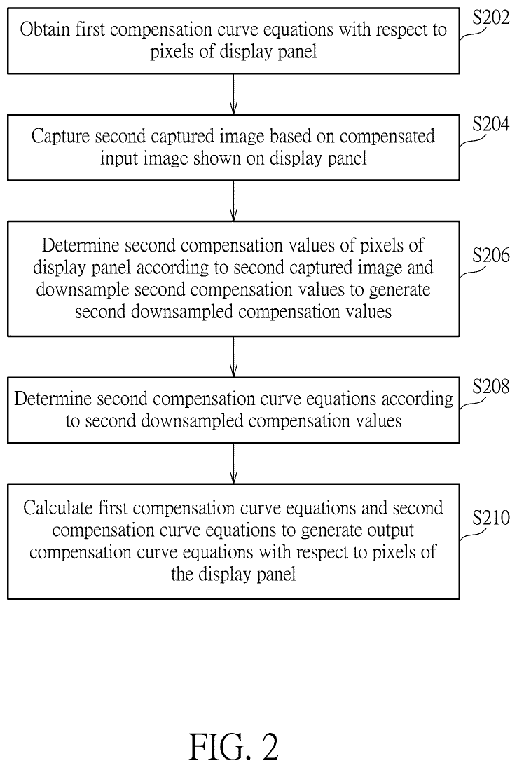

For an illustration of a multiple Demura compensation method of the display device 1, please refer to FIG. 2. FIG. 2 is a flow diagram of a procedure 2 according to an embodiment of the present invention. According to the procedure 2, in Step S202, the processing circuit 30 is configured to obtain first compensation curve equations with respect to pixels of the display panel 10. The processing circuit 30 may calculate the first compensation curve equations for pixels of the display panel 10. The first compensation curve equations could be determined based on first compensation values of a first captured image associated with an input image. The first compensation values may be determined according to the first captured image. The first captured image may be captured based on the input image been displayed on the display panel. The first compensation curve equations may be preconfigured and stored in the memory 40. The processing circuit 30 could read information of first compensation curve equations with respect to pixels of the display panel 10 from the memory 40.

Each pixel corresponds to a corresponding first compensation curve equation. For each pixel, the corresponding first compensation curve equation may be a function of compensation values for all grayscale values (grayscale levels). As such, each grayscale value of the pixel has a corresponding compensation value which could be calculated through the first compensation curve equation. For example, for an 8 bits image, each pixel has a grayscale value between 0 and 255. Each of the 256 grayscale values has a corresponding compensation value which can be calculated through the first compensation curve equation for the pixel. The first compensation curve equation may be expressed as follows:

y₁=a₁xⁿ+b₁x⁻¹+c₁ . . . (1)
where y₁ represents the first compensation value; x represents the pixel value of the pixel; a₁, b₁, c₁ represent coefficients of the first compensation curve equation, n is the natural number.

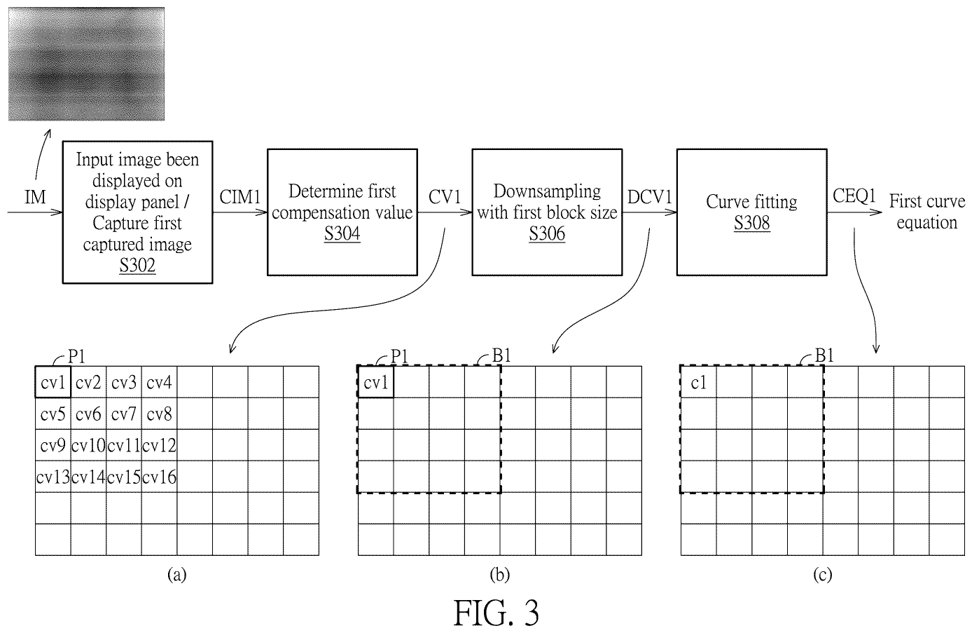

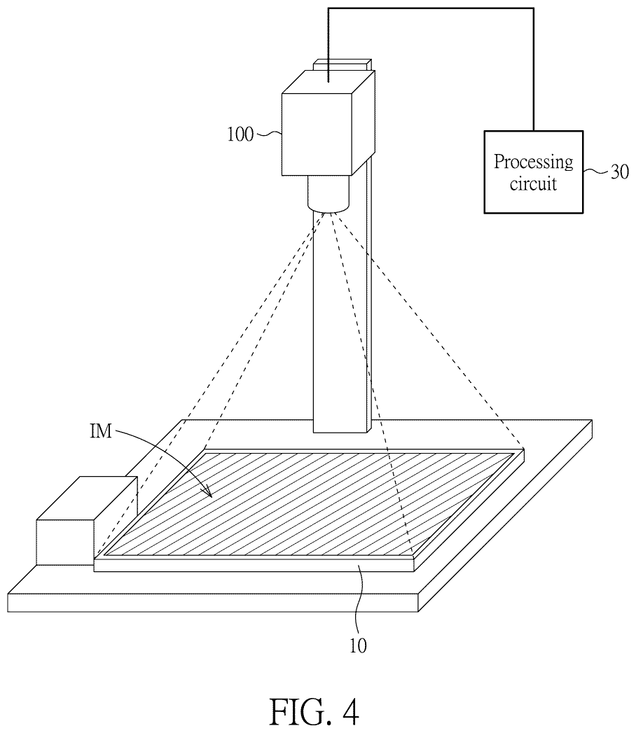

Regarding the method of determining first compensation curve equations with respect to the pixels of the display panel 10, please refer to FIG. 3. In Step S302, the image capturing device 100 may be configured to photograph the display panel 10 to generate a first captured image CIM1 based on an input image IM shown on the display panel 10. For example, as shown in FIG. 1 and FIG. 4, the image capturing device 100 is utilized to take photographs to generate captured images. The image capturing device 100 may be a camera. As shown in FIG. 4, the image capturing device 100 may be mounted and fixed on a test machine, and the image capturing device 100 may be placed near the display panel 10. The image capturing device 100 may be set to aim toward and align with the display region (e.g., screen) of the display panel 10 for shooting the display region of the display panel 10. The image capturing device 100 may be focused on the screen of the display panel 10 and capture the displayed image frame shown on the display panel 10 for generating a captured image.

Moreover, the driving circuit 20 may generate a driving signal corresponding to an input image IM to drive the pixels of the display panel 10, and the display panel 10 displays the input image IM accordingly. As shown in top left side of FIG. 3, the input image IM is an original image without Mura compensation. As the input image IM is displayed on the display panel 10, it could be clearly seen that there is a large amount of uneven brightness region, and thus the display panel 10 may have serious Mura defect problem. Furthermore, as shown in FIG. 4, when the display panel 10 is displaying the input image IM on the screen, the image capturing device 100 is controlled to capture the input image IM shown on the screen of the display panel 10 so as to generate a first captured image CIM1. The first captured image CIMI generated by the image capturing device 100 may be provided to the processing circuit 30. The image capturing device 100 may transmit the first captured image CIM1 to the processing circuit 30 via a wireless or wired connection.

In Step S304, the processing circuit 30 may determine the first compensation values CV1 of pixels of the display panel 10 according to the first captured image CIM1. The processing circuit 30 may analyze the first captured image CIM1 to determine Mura effect in the display panel 10. The processing circuit 30 may determine how serious the Mura effect is in the display panel 10. Accordingly, processing circuit 30 may calculate corresponding first compensation values for each pixel of the display panel 10. For example, the processing circuit 30 may perform grayscale compensation according to the first captured image, so as to obtain the first compensation values for the pixels. The processing circuit 30 may calculate the first compensation values CV1 for the pixels of the display panel 10 according to the first captured image CIM1 by utilizing any Demura (elimination of Mura effect) algorithm including the well-known Demura algorithm. The processing circuit 30 may calculate the first compensation values CV1 for the pixels according to a Demura table. The first compensation value could be the value for the pixel needed to be compensated. The first compensation value could be utilized to compensate the pixel of the display panel 100. The first compensation values of the embodiments could be grayscale values or luminance values for the pixels. For each pixel, the processing circuit 30 may determine first compensation values of the pixel for all grayscale values. Each grayscale value of the pixel has a corresponding first compensation value. For example, for an 8 bits image, each pixel has a grayscale value between 0 and 255. Each of the 256 grayscale values has a corresponding first compensation value. For example, as shown in the part (a) of FIG. 3, cv1 represents the first compensation values of all grayscale values for the pixel P1.

In Step S306, the processing circuit 30 may downsample the first compensation values CV1 to generate first downsampled compensation values DCV1 by using a first block size in each downsampling block. Each downsampling block includes pixels corresponding to the first block size. The first compensation values of a representative pixel for each downsampling block could be utilized to replace each pixel in the downsampling block, so as to generate the first downsampled compensation values. For example, as shown in the part (b) of FIG. 3, for the first block size of 4×4 in each downsampling block, the pixel P1 is one of the 4×4 pixels in the downsampling block B1. The pixel P1 may be selected as a representative pixel for the downsampling block B1. After downsampling in the Step S306, the first compensation values of each pixel in the downsampling block B1 could be replaced with the first compensation values cv1 of the pixel P1.

In Step S308, the processing circuit 30 may perform a curve fitting operation on the first downsampled compensation values DCV1 to generate first compensation curve equations CEQ1 with respect to the pixels of the display panel 10. For each pixel, the processing circuit 30 may perform a curve fitting operation on the first downsampled compensation values corresponding to the pixel to generate a corresponding first compensation curve equation for the pixel. Therefore, each pixel has a corresponding first compensation curve equation. Each grayscale value of the pixel has a corresponding first compensation value which could be calculated through the first compensation curve equation. The first compensation curve equations may be stored in the memory 40 for the following operations. The processing circuit 30 may store coefficients for each term of the first compensation curve equations into the memory 40 for the following operations. The first compensation curve equations may be used in the following operations for compensating the pixel of the display panel 10. For example, as shown in the part (c) of FIG. 3, for the first block size of 4×4 in each downsampling block, each pixel in the downsampling block B1 corresponds to the first compensation curve equation c1. Compensation values of all grayscale for each pixel of the downsampling block B1 could be calculated through the first compensation curve equation c1.

In another embodiment, since the manufacturing processes of display panels of a same batch are the same, the display panels of the same batch usually have identical characteristics and thus the Mura distribution of different display panels may be the same or similar. In Step S202, a test display panel (e.g., golden sample panel) may be selected from the manufacturing batch which is the same as the display panel 10. The first compensation curve equations may be preconfigured and stored in the memory 40 in advance by using the test display panel. The display panel 10 and the test display panel may be manufactured from the same batch. The display panel 10 and the test display panel may have the same or similar Mura distribution. Please further refer to FIG. 3. In Step S302, before the manufacturing test of the display panel 10, the test display panel may be configured to display the input image IM. The image capturing device 100 may capture the displayed image frame (e.g., input image IM) shown on the test display panel for generating a first captured image CIM1. The first captured image CIM1 can be processed via the abovementioned steps of FIG. 3 so as to generate the first compensation curve equations CEQ1 for the pixels of the display panel. The calculated first compensation curve equations CEQ1 of the display panel can be used as a reference for subsequent panel manufacturing test since panel products in the same batch of manufacturing process may have the same or similar characteristics. The first compensation curve equations CEQ1 determined based on the input image IM to be displayed on the test display panel may be stored in the memory 40. The coefficients for each term of the first compensation curve equations into the memory 40 for the following operations. The first compensation curve equations CEQ1 may be used in the following operations for compensating the pixel of the display panel 10.

In other words, the first compensation curve equations may be obtained by testing the test display panel and could be used as a reference for subsequent panel manufacturing test. The first compensation curve equations for the pixels may be calculated and pre-stored in the memory 40 in advance for the following operations. Therefore, the processing circuit 30 could directly and rapidly read the information of the first compensation curve equations from the memory 40 for the following operations.

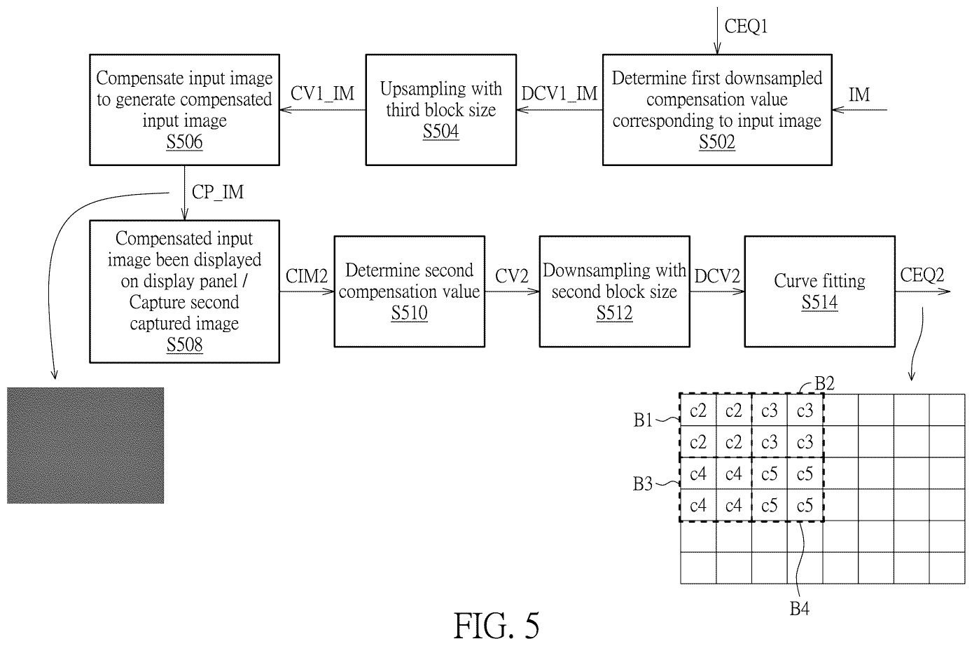

In Step S204, the processing circuit 30 is configured to calculate a compensated input image according to the input image and the first compensation curve equations, and the compensated input image can be displayed by the display panel 10. Therefore, the image capturing device 100 could capture a second captured image based on the compensated input image shown on the display panel 10. For example, please refer to FIG. 5. In Step S502, the processing circuit 30 may read the first compensation curve equations CEQ1 from the memory 40. The processing circuit 30 is configured to determine first downsampled compensation values DCV1_IM corresponding to the input image IM according to the first compensation curve equations CEQ1. For each pixel of the input image IM, the processing circuit 30 may determine a corresponding first downsampled compensation value according to the first compensation curve equation of the pixel. The processing circuit 30 may substitute a pixel value of the pixel into the first compensation curve equation to obtain the corresponding first downsampled compensation value for the pixel of the input image IM. For each pixel of the input image IM, the processing circuit 30 may determine the first downsampled compensation value corresponding to the pixel by using linear interpolation based on the first compensation curve equation.

Since the first downsampled compensation values DCV1_IM corresponding to the input image IM are derived from the first compensation curve equations calculated based on the first downsampled compensation values. In Step S504, the processing circuit 30 may upsample the first downsampled compensation values DCV1_IM corresponding to the input image IM using a third block size in each upsampling block to generate first compensation values CV1_IM corresponding to the input image IM. The third block size may be the same as the block size of the input image IM. Each pixel of the input image IM has the corresponding first downsampled compensation value. For example, the third block size of upsampling may be 1×1. After upsampling the first downsampled compensation values DCV1 IM, the first compensation values CV1_IM corresponding to the input image IM would be utilized for real size of the input image IM. In Step S506, the processing circuit 30 may perform a Mura compensation on each pixel in the input image IM by using the first compensation values CV1_IM, to generate the compensated input image CP_IM. For each pixel of the compensated input image CP_IM, the processing circuit 30 may add a pixel value of the pixel in the input image IM to the first compensation value corresponding to the pixel to generate a pixel value for the pixel of the compensated input image CP_IM. Therefore, the first compensation value could be applied to perform the Mura compensation for the first time.

In Step S508, the driving circuit 20 generates driving signal corresponding to the compensated input image CP_IM to drive the pixels of the display panel 10, and the compensated input image CP_IM could be display by the display panel 10. Since the first compensation values derived from the first compensation cure equations could be applied to compensate the input image IM and accordingly generate the compensated input image CP_IM. As shown in bottom left side of FIG. 5, the compensated input image CP_IM is a compensated image by using first compensation values. As the compensated input image CP_IM is displayed on the display panel 10, it can be seen that some of the Mura regions have been improved, but there are still some regions which reveal the Mura defects. When the display panel 10 is displaying the compensated input image CP_IM on the screen, the image capturing device 100 is configured to capture the compensated input image CP_IM shown on the screen of the display panel 10 so as to generate a second captured image CIM2. The second captured image CIM2 generated by the image capturing device 100 may be provided to the processing circuit 30.

In Step S206, the processing circuit 30 may determine second compensation values CV2 of the pixels of the display panel 10 according to the second captured image CIM2 and downsample the second compensation values CV2 to generate second downsampled compensation values DCV2 for the pixels of the display panel 10. For example, please further refer to FIG. 5. In Step S510, the processing circuit 30 may analyze the second captured image CIM2 to determine Mura effect in the display panel 10. The processing circuit 30 may calculate corresponding second compensation values for each pixel of the display panel 10. The processing circuit 30 may perform grayscale compensation according to the second captured image CIM2, so as to obtain the second compensation values CV2 for the pixels. The processing circuit 30 may calculate the second compensation values CV2 according to the second captured image CIM2 by utilizing any Demura algorithm including the well-known Demura algorithm. The second compensation values CV2 could be utilized to compensate the pixels of the display panel 100. The second compensation values CV2 of the embodiments could be grayscale values or luminance values for the pixels. For each pixel, the processing circuit 30 may determine the second compensation values of the pixel for all grayscale values. Each grayscale value of the pixel has a corresponding second compensation value.

In Step S512, the processing circuit 30 may downsample the second compensation values CV2 to generate second downsampled compensation values DCV2 by using a second block size in each downsampling block. Each downsampling block includes pixels corresponding to the second block size. The second compensation values of a representative pixel for each downsampling block could be utilized to replace each pixel in the downsampling block, so as to generate the second downsampled compensation values. In an embodiment, the first block size of downsampling utilized in Step S306 could be greater than the second block size of downsampling utilized in Step S512.

Since the change in panel load would be smaller than before and the luminance difference near the pixel would become smaller after the first compensation, the image capturing device 100 can capture more accurate optical data (i.e. second captured image). Accordingly, the processing circuit 30 may determine more accurate second compensation value for second Mura compensation. Moreover, as the second block size using in the second Mura compensation is smaller than the first block size using in the first Mura compensation, the second compensation values could be determined based on more precise pixel luminance information. Therefore, the second compensation values can be applied to perform a more complete and precise Mura compensation, thus capable of eliminating the Mura effect of the display panel more effectively. As such, the Mura compensation for first time could also be referred to as rough-tune compensation and the Mura compensation for second time can be referred to as fine-tune compensation.

In Step S208, after generating the second downsampled compensation values, the processing circuit 30 may determine second compensation curve equations according to the second downsampled compensation values. For example, please further refer to FIG. 5. In Step S514, the processing circuit 30 may perform a curve fitting operation on the second downsampled compensation values DCV2 to generate second compensation curve equations CEQ2 with respect to the pixels of the display panel 10. For each pixel, the processing circuit 30 may perform a curve fitting operation on the second downsampled compensation values corresponding to the pixel to generate a corresponding second compensation curve equation of the pixel. The second compensation curve equation may be expressed as follows:

y₂=a₂xⁿ+b₂x⁻¹+c₂ . . . (2)
where y₂ represents the second compensation value; x represents the pixel value of the pixel; a₂, b₂, c₂ represent coefficients of the second compensation curve equation, n is the natural number.

Therefore, each pixel corresponds to a corresponding second compensation curve equation. Each grayscale value of the pixel has a corresponding second compensation value which could be calculated through the second compensation curve equation. The second compensation curve equations CEQ2 may be stored in the memory 40. The processing circuit 30 may store coefficients for each term of the second compensation curve equations CEQ2 into the memory 40 for the following operations. For example, as shown in the part (a) of FIG. 5, for the second block size of 2×2 in each downsampling block, each pixel in the downsampling block B1 corresponds to the second compensation curve equation c2. Compensation values of all grayscale for each pixel of the downsampling block B1 could be calculated through the second compensation curve equation c2. Each pixel in the downsampling block B2 corresponds to the second compensation curve equation c3, and the like.

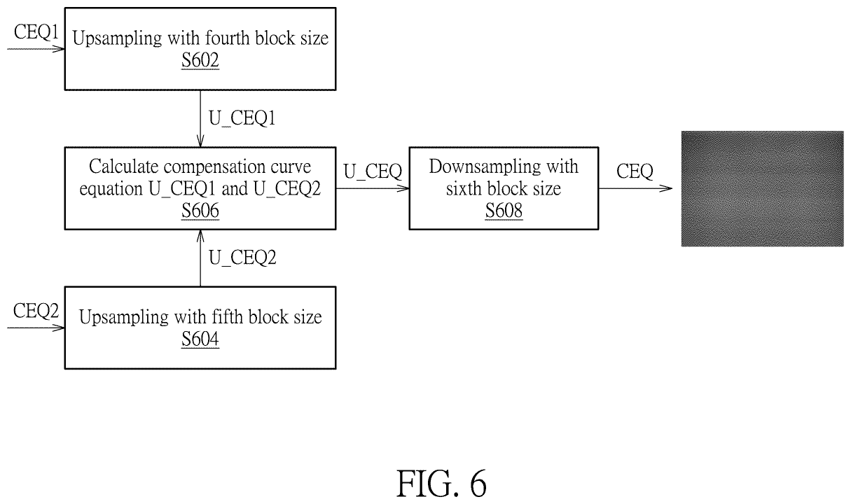

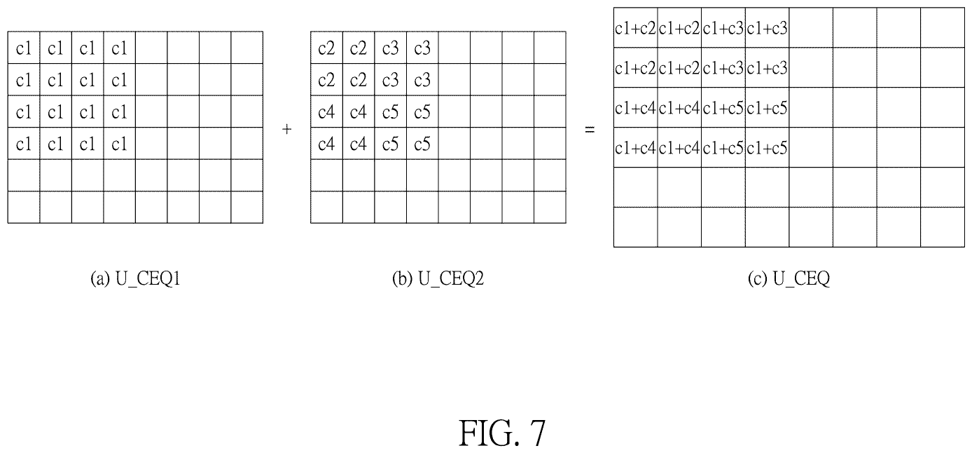

In Step S210, the processing circuit 30 is configured to calculate the first compensation curve equations CEQ1 and the second compensation curve equations CEQ2 to generate output compensation curve equations CEQ with respect to the pixels of the display panel 10. For example, the processing circuit 30 performs a merge calculation according to the first compensation curve equations CEQ1 and the second compensation curve equations CEQ2 to generate the output compensation curve equations CEQ. For example, please refer to FIG. 6. In Step S602, the processing circuit 30 may upsample the first compensation curve equations CEQ1 using a fourth block size in each upsampling block to generate the first upsampled compensation curve equations U_CEQ1 for the pixels of the display panel 10. For example, the fourth block size of upsampling may be 1×1. For example, as shown in the part (a) of FIG. 7, first upsampled compensation curve equations U_CEQ1 may be upsampled to the entire block size of 1×1, since the first compensation curve equations CEQ1 are determined at a downsampling block size of 4×4. In an embodiment, the fourth block size and the fifth block size may be the same block sizes. For example, the fourth block size and the fifth block size may be the same as the block size of the input image IM or display panel 10.

In Step S604, the processing circuit 30 may upsample the second compensation curve equations CEQ2 using a fifth block size in each upsampling block to generate the second upsampled compensation curve equations U_CEQ2 for the pixels of the display panel 10. For example, the fifth block size of upsampling may be 1×1. For example, as shown in the part (b) of FIG. 7, first upsampled compensation curve equations U_CEQ2 may be upsampled to the entire block size of 1×1, since the first compensation curve equations CEQ2 are determined at a downsampling block size of 2×2.

In Step S606, the processing circuit 30 may perform a merge calculation based on the first upsampled compensation curve equations U_CEQ1 and the second upsampled compensation curve equations U_CEQ2 to generate merged compensation curve equations U_CEQ for the pixels of the display panel 10. For example, the merge calculation could be any type of algebraic operation. For example, the merge calculation could be an addition operation, a subtraction operation, a multiplication operation, a division operation, an OR operation, a XOR operation or any combination thereof. Take performing an addition operation for example to illustrate, as shown in the part (c) of FIG. 7, For each pixel, the merged compensation curve equation of the pixel may be obtained by adding the first upsampled compensation curve equation of the pixel to the second upsampled compensation curve equation of the pixel. As such, compensation values of all grayscale for each pixel could be calculated through the corresponding compensation curve equation.

In Step S608, the processing circuit 30 may downsample the merged compensation curve equations U_CEQ by using a sixth block size in each downsampling block to generate output compensation curve equations CEQ for the pixels of the display panel 10. The output compensation curve equations CEQ may be stored in the memory 40. Each downsampling block includes pixels corresponding to the sixth block size. In an embodiment, the sixth block size of downsampling utilized in Step S608 may be equal to the second block size of downsampling utilized in Step S512. The output compensation curve equation may be expressed as follows:

y₃=a₃xⁿ+b₃x⁻¹+c₃ . . . (3)
where y₃ represents the compensation value; x represents the pixel value of the pixel; a₃, b₃, c₃ represent coefficients of the output compensation curve equation, n is the natural number.

Therefore, the output compensation curve equations CEQ could be applied to determine output compensation values for the pixels and an output compensated image could be generated according to the input image IM and the output compensation values. As shown in middle right side of FIG. 7, the output compensated image displayed on the display panel 10 reveals almost no Mura defect. A high precise and accurate compensation result is exactly achieved. In other words, with the merge usage of first compensation curve and the second compensation curve equations (include rough-tune compensation information and fine-tune compensation information), the output compensation curve equations, the output compensation curve equations CEQ for the pixels of the display panel 10 could be utilized to determine compensation values to compensate the pixels of the display panel 10 for providing more precise Mura compensation, thus significantly improving compensation accuracy.

According to different design, in some embodiments, the implementation manner of the processing circuit 30 may be a hardware circuit. In some embodiments, the implementation manner of the processing circuit 30 may be firmware (e.g., a combination of a hardware device and computer instructions and data that reside as read-only software on the hardware device), software (e. g., a program), or a combination thereof. In some embodiments, the implementation manner of the processing circuit 30 may be a combination of hardware, firmware and software.

In terms of hardware, the above-mentioned processing circuit 30 may be implemented as a logic circuit in an integrated circuit. For example, the related functions of the processing circuit 30 may be implemented in one or more controllers, microcontrollers, microprocessors, application-specific integrated circuits (ASICs), digital signal processors (DSPs), field programmable gate arrays (FPGAs), central processing units (CPUs) and/or various logic blocks, modules and circuits in other processing units. The related functions of the processing circuit 30 may be implemented as hardware circuits by using hardware description languages (such as Verilog HDL or VHDL) or other suitable programming languages, such as various logic blocks, modules and circuits in integrated circuits.

In terms of software and/or firmware, the above-mentioned related functions of the processing circuit 30 may be implemented as programming codes. For example, the processing circuit 30 is realized by using general programming languages or other suitable programming languages. The programming code may be recorded/stored in a “non-transitory machine-readable storage medium”. In some embodiments, the non-transitory machine-readable storage medium includes, for example, a semiconductor memory and/or a storage device. The semiconductor memory includes a memory card, a read only memory (ROM), a flash memory, a programmable logic circuit or other semiconductor memories. The storage device includes a tape, a disk, a hard disk drive (HDD), a solid-state drive (SSD), or other storage devices. An electronic device (such as a computer, a CPU, a controller, a microcontroller, or a microprocessor) may read and execute the programming code from the non-transitory machine-readable storage medium, thereby realizing the related functions of processing circuit 30.

To sum up, the embodiments of the invention can provide a multiple Demura compensation method to improve compensation accuracy. The embodiments of the invention can utilize the first compensation data (e.g., first compensation curve equations for rough Mura compensation) which is pre-stored in the memory to determine the second compensation data (e.g., second compensation curve equations for fine Mura compensation) for performing a better Mura compensation for the pixels of the display panel. Moreover, the embodiments of the invention can merge the first compensation data and the second compensation data to generate the output compensation curve equations for compensating the pixels of the display panel, thereby providing more precise Mura compensation and significantly improving compensation accuracy. Besides, the memory of the embodiments merely needs to store information of the output compensation curve equation, thus the embodiments of the invention do not require additional external memory for storing a large amount of data.

Those skilled in the art will readily observe that numerous modifications and alterations of the device and method may be made while retaining the teachings of the invention. Accordingly, the above disclosure should be construed as limited only by the metes and bounds of the appended claims.

1. A multiple Demura compensation method, comprising:
obtaining first compensation curve equations with respect to pixels of a display panel, wherein the first compensation curve equations being determined based on first compensation values of a first captured image associated with an input image;
capturing a second captured image based on a compensated input image shown on the display panel, wherein the compensated input image being determined according to the input image and the first compensation curve equations;
determining second compensation values of pixels of the display panel according to the second captured image and downsampling the second compensation values to generate second downsampled compensation values;
determining second compensation curve equations according to the second downsampled compensation values; and
calculating the first compensation curve equations and the second compensation curve equations to generate output compensation curve equations with respect to the pixels of the display panel.

2. The multiple Demura compensation method of claim 1, further comprising:
capturing the first captured image based on the input image shown on the display panel or a test display panel;
determining the first compensation values for pixels of the display panel according to the first captured image;
downsampling the first compensation values to generate first downsampled compensation values; and
performing a curve fitting operation on the first downsampled compensation values to generate the first compensation curve equations with respect to the pixels of the display panel.

3. The multiple Demura compensation method of claim 1, further comprising:
determining first downsampled compensation values corresponding to the input image according to the first compensation curve equations;
upsampling the first downsampled compensation values corresponding to the input image to generate first compensation values corresponding to the input image; and
compensating the input image by using the first compensation values corresponding to the input image to generate the compensated input image.

4. The multiple Demura compensation method of claim 1, further comprising:
performing a curve fitting operation on the second downsampled compensation values of the pixels to generate the second compensation curve equations with respect to the pixels of the display panel.

5. The multiple Demura compensation method of claim 1, wherein the first compensation values are downsampled using a first block size in each downsampling block to generate first downsampled compensation values, and the second downsampled compensation values are generated by using a second block size in each downsampling block, wherein the first block size is greater than the second block size.

6. The multiple Demura compensation method of claim 1, further comprising:
upsampling the first compensation curve equations to generate first upsampled compensation curve equations;
upsampling the second compensation curve equations to generate second upsampled compensation curve equations;
performing a merge calculation according to the first compensation curve equations and the second compensation curve equations to generate merged compensation curve equations for the pixels of the display panel;
downsampling the merged compensation curve equations to generate the output compensation curve equations for the pixels of the display panel.

7. A processing circuit, wherein the processing circuit is configured to obtain first compensation curve equations with respect to pixels of a display panel, wherein the first compensation curve equations are determined based on first compensation values of a first captured image associated with an input image, the processing circuit is configured to determine second compensation values of the pixels of the display panel according to a second captured image and downsample the second compensation values to generate second downsampled compensation values, wherein the second captured image is captured based on a compensated input image shown on the display panel, and the compensated input image is determined according to the input image and the first compensation curve equations, wherein the processing circuit is configured to determines second compensation curve equations according to the second downsampled compensation values and calculate the first compensation curve equations and the second compensation curve equations to generate output compensation curve equations with respect to the pixels of the display panel.

8. The processing circuit of claim 7, wherein the first captured image is captured based on the input image shown on the display panel or a test display panel, wherein the processing circuit is configured to determine the first compensation values for pixels of the display panel according to the first captured image, downsample the first compensation values to generate first downsampled compensation values, and perform a curve fitting operation on the first downsampled compensation values to generate the first compensation curve equations with respect to the pixels of the display panel.

9. The processing circuit of claim 7, wherein the processing circuit is configured to determine first downsampled compensation values corresponding to the input image according to the first compensation curve equations, upsample the first downsampled compensation values corresponding to the input image to generate first compensation values corresponding to the input image, and compensate the input image by using the first compensation values corresponding to the input image to generate the compensated input image.

10. The processing circuit of claim 7, wherein the processing circuit is configured to perform a curve fitting operation on the second downsampled compensation values of the pixels to generate the second compensation curve equations with respect to the pixels of the display panel.

11. The processing circuit of claim 7, wherein the first compensation values are downsampled using a first block size in each downsampling block to generate first downsampled compensation values are generated, and the second downsampled compensation values are generated by using a second block size in each downsampling block, wherein the first block size is greater than the second block size.

12. The processing circuit of claim 7, wherein the processing circuit is configured to upsample the first compensation curve equations to generate first upsampled compensation curve equations, upsample the second compensation curve equations to generate second upsampled compensation curve equations, perform a merge calculation according to the first compensation curve equations and the second compensation curve equations to generate merged compensation curve equations, and downsample the merged compensation curve equations to generate the output compensation curve equations for the pixels of the display panel.

13. A display device, comprising:
a display panel;
a memory, configured to store first compensation curve equations with respect to pixels of a display panel, wherein the first compensation curve equations are determined based on first compensation values of a first captured image associated with an input image; and
a processing circuit, configured to determine second compensation values of the pixels of the display panel according to a second captured image and downsample the second compensation values to generate second downsampled compensation values, wherein the second captured image is captured based on a compensated input image shown on the display panel, and the compensated input image is determined according to the input image and the first compensation curve equations;
wherein the processing circuit determines second compensation curve equations according to the second downsampled compensation values, and calculates the first compensation curve equations and the second compensation curve equations to generate output compensation curve equations with respect to the pixels of the display panel.

14. The display device of claim 13, wherein the first captured image is captured based on the input image shown on the display panel or a test display panel, wherein the processing circuit is configured to determine the first compensation values for pixels of the display panel according to the first captured image, downsample the first compensation values to generate first downsampled compensation values, and perform a curve fitting operation on the first downsampled compensation values to generate the first compensation curve equations with respect to the pixels of the display panel.

15. The display device of claim 13, wherein the processing circuit is configured to determine first downsampled compensation values corresponding to the input image according to the first compensation curve equations, upsample the first downsampled compensation values corresponding to the input image to generate first compensation values corresponding to the input image, and compensate the input image by using the first compensation values corresponding to the input image to generate the compensated input image.

16. The display device of claim 13, wherein the processing circuit is configured to perform a curve fitting operation on the second downsampled compensation values of the pixels to generate the second compensation curve equations with respect to the pixels of the display panel.

17. The display device of claim 13, wherein the first compensation values are downsampled using a first block size in each downsampling block to generate first downsampled compensation values are generated, and the second downsampled compensation values are generated by using a second block size in each downsampling block, wherein the first block size is greater than the second block size.

18. The display device of claim 13, wherein the processing circuit is configured to upsample the first compensation curve equations to generate first upsampled compensation curve equations, upsample the second compensation curve equations to generate second upsampled compensation curve equations, perform a merge calculation according to the first compensation curve equations and the second compensation curve equations to generate merged compensation curve equations, and downsample the merged compensation curve equations to generate the output compensation curve equations for the pixels of the display panel.
